(19) United States
(12) Patent Application Publication
(10) Pub. No.: US 2024/0056350 A1
(43) Pub. Date: Feb. 15, 2024

(54) SYSTEM AND METHOD FOR A NETWORK CONFIGURATION FOR MEDIA DISTRIBUTION USING A GENETIC ALGORITHM

(71) Applicant: Dell Products L.P., Round Rock, TX (US)

(72) Inventor: Ahmed Khalid, Cork (IE)

(21) Appl. No.: 17/884,706

(22) Filed: Aug. 10, 2022

(51) Int. Cl. H04L 41/0803; H04W 24/02

(52) U.S. Cl. CPC H04L 41/0803; H04W 24/02

(57) ABSTRACT

A method for determining a network configuration, the method comprising: obtaining, by a network configuration manager, a network configuration request for configuring client service regions, wherein the network configuration specifies configuring the transmission of media from the media providing service to neighboring base stations of the client service regions, in response to the obtaining: obtaining a current generation of multi-variable chromosomes, applying a fitness function on each of the current generation to obtain a set of confidence scores, wherein each of the set of confidence scores corresponds to one of the current generation of multi-variable chromosomes, selecting, based on the set of confidence scores, a highest scored multivariable chromosome, wherein the highest scored multi-variable chromosome comprises a plurality of network attributes, based on the selecting, determining the network configuration using the plurality of network attributes, and initiating the network configuration on the neighboring base stations.

### BACKGROUND

Computing devices in a system may be operated by clients. The clients may obtain media based on network configurations of client service regions in which the media is provided. The network configuration may influence the quality of the media distribution for the clients.

### BRIEF DESCRIPTION OF DRAWINGS

Certain embodiments disclosed herein will be described with reference to the accompanying drawings. However, the accompanying drawings illustrate only certain aspects or implementations disclosed herein by way of example and are not meant to limit the scope of the claims.

FIG. 1A shows a diagram of a system in accordance with one or more embodiments disclosed herein.

FIG. 1B shows a second diagram of the system in accordance with one or more embodiments disclosed herein.

FIG. 2 shows a flowchart for determining a network configuration using a genetic algorithm in accordance with one or more embodiments disclosed herein.

FIGS. 3A-3D show an example in accordance with one or more embodiments disclosed herein.

FIG. 4 shows a diagram of a computing device in accordance with one or more embodiments disclosed herein.

### DETAILED DESCRIPTION

Specific embodiments will now be described with reference to the accompanying figures. In the following description, numerous details are set forth as examples disclosed herein. It will be understood by those skilled in the art that one or more embodiments of the present disclosure may be practiced without these specific details and that numerous variations or modifications may be possible without departing from the scope disclosed herein. Certain details known to those of ordinary skill in the art are omitted to avoid obscuring the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

As used herein, the term operatively connected, or operative connection, means that there exists between elements/components/devices a direct or indirect connection that allows the elements to interact with one another in some way. For example, the term ‘operatively connected’ may refer to any direct (e.g., wired and/or wireless directly between two devices or components) or indirect (e.g., wired and/or wireless connections between any number of devices or components connecting the connected devices) connection. Thus, any path through which information may travel may be considered an operative connection.

In general, embodiments disclosed herein relate to a method and system for managing network configurations for a set of client service regions. The network configuration may be for the network operations, of the set of client service regions, for the purpose of distributing media. The media, e.g., videos, video streams, etc., may be distributed via neighboring base stations (each associated with a client service region) that connect to the client devices in the client service region that are the ultimate destinations of the media.

In one or more embodiments disclosed herein, the network configuration includes configuring the video bitrate or a video format (e.g., sd, hd, 4 k, etc.) for each subsection of client devices in each client service region. The network configuration may be initiated by a network configuration manager that implements a genetic algorithm to determine a recommended network configuration, such as, for example, an optimal network configuration. The genetic algorithm may include obtaining an initial population of multi-variable chromosomes. Each multi-variable chromosome may correspond to a viable network configuration. The initial population may be generated by performing modifications to the values specified in the multi-variable chromosomes, where each modification results in a new multi-variable chromosomes in the initial population. A fitness function is performed on each multi-variable chromosome to determine a confidence score for the corresponding network configuration. Based on the confidence scores, a set of parent chromosomes are determined, and a new set of modifications are performed on the parent chromosomes to obtain a new generation of multivariable chromosomes. The fitness function may be applied to the new generation of multi-variable chromosomes to obtain new confidence scores. The process of determining the parent chromosomes, obtaining a new generation of chromosomes, and applying the fitness function may be repeated until a termination condition is met. After the termination condition is met, the highest scoring multi-variable chromosome of the most recent generation is selected. The corresponding network configuration of the highest scoring multi-variable chromosome is implemented on the set of client service regions.

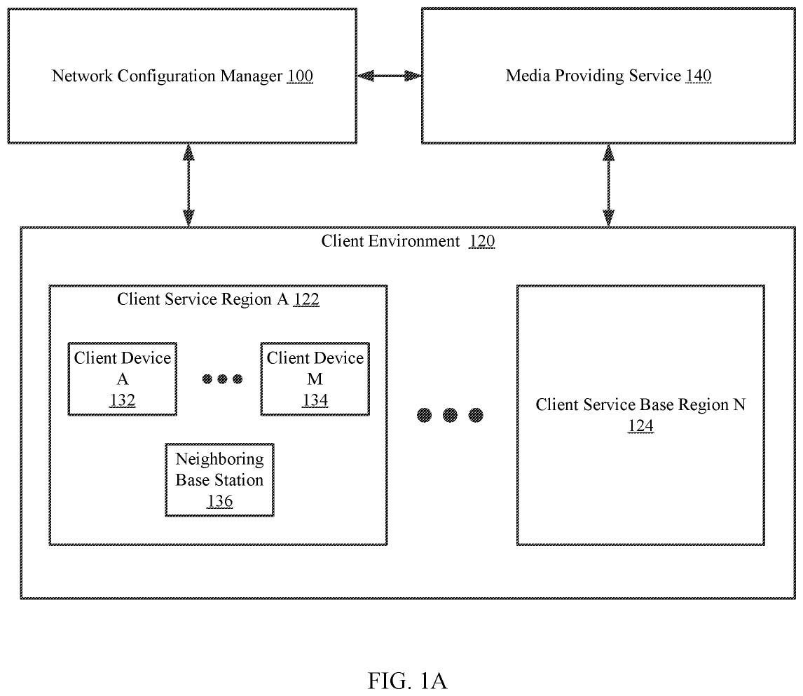

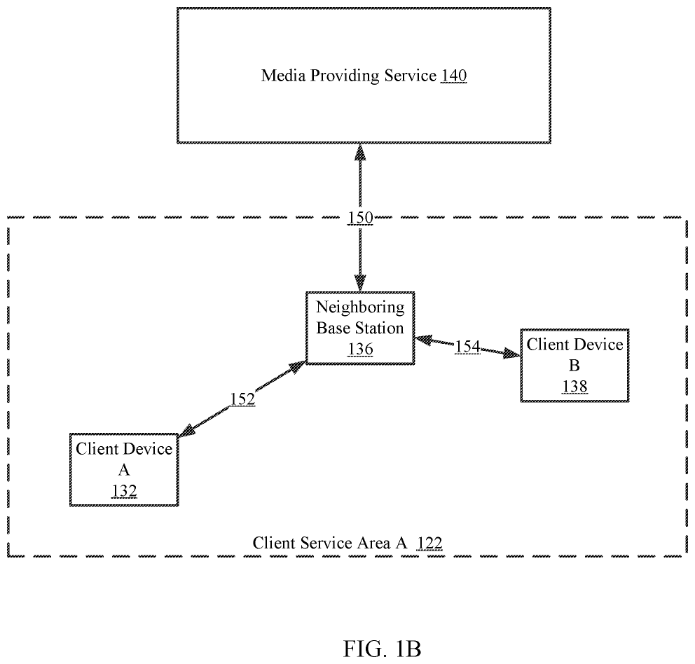

FIG. 1A shows an example system in accordance with one or more embodiments disclosed herein. The system includes a network configuration manager (100), a media providing service (140), and a client environment (120). The client environment (120) may include any number of client service regions (122, 124). The system may include additional, fewer, and/or different components without departing from the disclosure. Each component may be operatively connected to any of the other components via any combination of wired and/or wireless connections. Each component illustrated in FIG. 1A is discussed below.

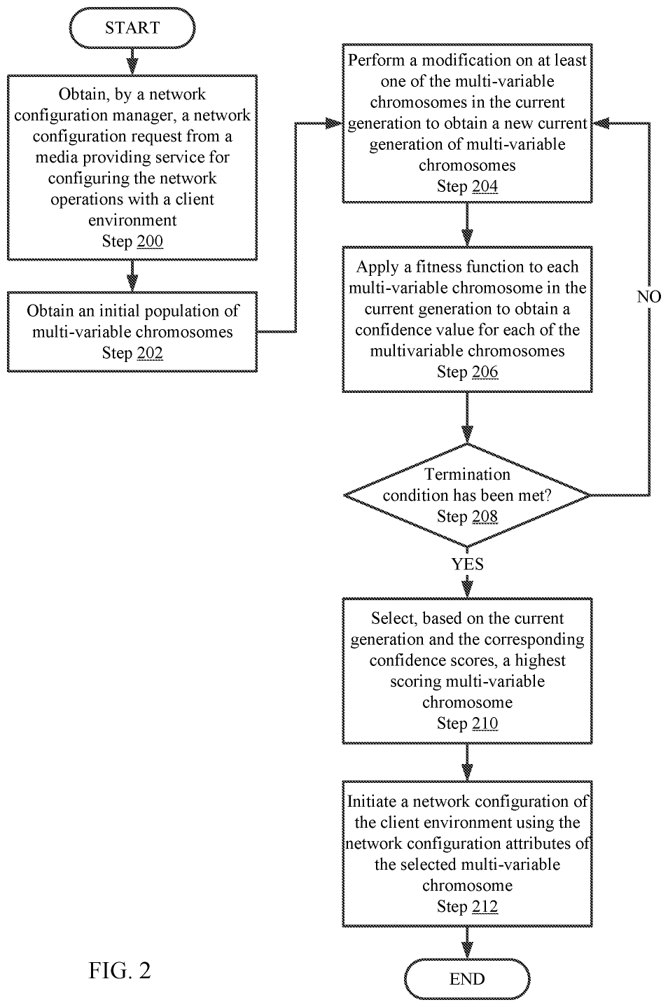

In one or more embodiments, the network configuration manager (100) includes functionality for determining the network configuration for the client environment (120). The network configuration may be for how media is distributed by the media providing service (140). The network configuration may be provided to the media providing service (140) and/or to the neighboring base stations (136) of the client service regions (122, 124). The network configuration may be determined in accordance with FIG. 2.

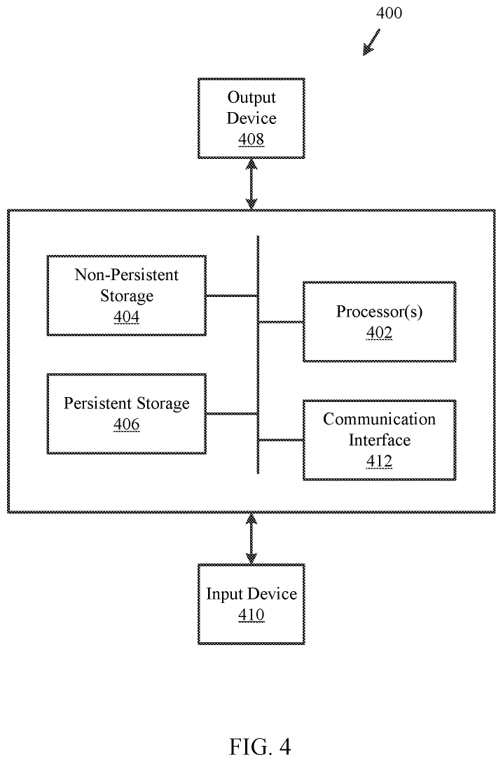

In one or more embodiments disclosed herein, the network configuration manager (100) is implemented as a computing device (see e.g., FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the network configuration manager (100) described throughout this disclosure.

In one or more embodiments disclosed herein, each network configuration manager (100) is implemented as a logical device. The logical device may utilize the computing resources of any number of computing devices and thereby provide the functionality of the network configuration manager (100) described throughout this disclosure.

In one or more embodiments, the media providing service (140) provides media to the client devices (132, 134) in the client environment (120). The media may include, for example, one or more videos, data streams, picture streams, video streams, and audio streams. The media may be distributed, for example, via a multicast. Other media may be provided without departing from the disclosure. In one or more embodiments, the media providing service (140) may provide the media in accordance with the network configuration determined by the network configuration manager (100).

For additional details regarding the distribution of the media from the media providing service (140) to the client environment (120), see, e.g., FIG. 1B.

In one or more embodiments disclosed herein, the media providing service (140) is implemented as a computing device (see e.g., FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the media providing service (140) described throughout this disclosure.

In one or more embodiments disclosed herein, each media providing service (140) is implemented as a logical device. The logical device may utilize the computing resources of any number of computing devices and thereby provide the functionality of the media providing service (140) described throughout this disclosure.

In one or more embodiments disclosed herein, the client environment (120) includes a number of client service regions (122, 124). Each client service region (122, 124) may include a neighboring base station (136) that is operatively connected to a set of client devices (132, 134). The connection between each client device (122, 124) and the neighboring base station (136) may be based on the proximity in distance. For example, the client devices (132, 134) may be operatively connected to the neighboring base stations (136) via a wireless connection. The network bandwidth, latency, and/or other network performance metrics may be based on the network strength between the client devices (132, 134) and the neighboring base stations (136). The distribution of the network strength between the client devices (132, 134) and the neighboring base station (136).

While FIG. 1A illustrates the client devices (132, 134) as being associated with only one client service region (e.g., 122), each client device (132, 134) may be associated with two or more client service regions (122, 124). In this manner, the client devices (122) may be serviced via any number of neighboring base stations (e.g., 136). For example, for client service regions that are associated with a single frequency network cluster (further discussed below), the client devices in the SFN cluster may be serviced (e.g., obtain transmitted data) from any one or more neighboring base stations in the SFN cluster.

In one or more embodiments disclosed herein, each client device (132, 134) is implemented as a computing device (see e.g., FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the client device (132, 134) described throughout this disclosure.

In one or more embodiments disclosed herein, each client device (132, 134) is implemented as a logical device. The logical device may utilize the computing resources of any number of computing devices and thereby provide the functionality of the client environments (132, 134) described throughout this disclosure.

In one or more embodiments disclosed herein, each neighboring base station (136) is implemented as a computing device (see e.g., FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the neighboring base station (136) described throughout this disclosure.

In one or more embodiments disclosed herein, each neighboring base station (136) is implemented as a logical device. The logical device may utilize the computing resources of any number of computing devices and thereby provide the functionality of the neighboring base station (136) described throughout this disclosure.

While the network configuration manager (100) is illustrated in FIG. 1A as being a separate component, the network configuration manager (100), and any components thereof, may be executed as part of the media providing service (140) and/or any other components illustrated in FIG. 1A without departing from the disclosure.

To further illustrate the distribution of media in the system, FIG. 1B shows a second diagram of the example system. The second diagram illustrates a first operative connection between the media providing service and the neighboring base station (136) of client service area A (122). The first operative connection (150) (i.e., the operative connection between the media providing service (140) and the neighboring base station (136)) may be implemented, for example, via a network that provides connectivity to the neighboring base station (136). The network may include any number of network devices that forward and/or route obtained packets towards a destination of the neighboring base station (136). The first operative connection (150) is used to stream the media to the neighboring base station (136).

In one or more embodiments, the neighboring base station (136) distributes the obtained data to the client devices (132, 138). The distribution may be performed via a second operative connection (152) between client device A (132) and the neighboring base station (136), and a third operative connection (154) between client device B (138) and neighboring base station (136). The second and third operative connections (152, 154) may be wireless connections that are characterized by the corresponding signal strength. A larger distance between client device A (132) and the neighboring base station (136), for example, may produce a low signal strength than a shorter distance between client device B (138) and the neighboring base station (136). The signal strength of the client devices (132, 138), and any other client devices (if any, not shown) in the client service area (122), may be used for the determination of the network configuration discussed in FIG. 2.

FIG. 2 shows a flowchart for performing entity resolution in accordance with one or more embodiments disclosed herein. The method shown in FIG. 2 may be performed by, for example, an entity resolution manager (e.g., 100, FIG. 1). Other components of the system illustrated in FIG. 1 may perform the method of FIG. 2 without departing from the disclosure.

While the various steps in the flowcharts are presented and described sequentially, one of ordinary skill in the relevant art will appreciate that some or all of the steps may be executed in different orders, may be combined or omitted, and some or all steps may be executed in parallel. In one embodiment disclosed herein, the steps shown in FIG. 2 may be performed in parallel with any other steps shown in FIG. 2 without departing from the scope disclosed herein.

Turning to FIG. 2, in step 200, a network configuration request is obtained from a media providing service. In one or more embodiments, the network configuration request specifies performing a network configuration of the neighboring base stations in each client service area in the client environment. The network configuration may be for the network operations performed during a streaming of data (e.g., a video, audio, etc.).

In step 202, an initial population of multi-variable chromosomes is obtained. In one or more embodiments, a multi-variable chromosome is a data structure that specified one or more network attributes associated with a potential network configuration. In one or more embodiments, the initial population is generated by obtaining an initial multi-variable chromosome (e.g., using a default set of network attributes) and modifying one or more variables of a copy of the network attributes, and generating a new multi-variable chromosome. The modifications may be performed for multiple copies of the default set of network attributes to generate multiple multi-variable chromosomes. The set of multi-variable chromosomes may be referred to as the initial population.

For example, the network attributes may include a clustering of client service areas that are each associated with a single frequency network (SFN). In one or more embodiments, a SFN is a grouping of devices that transmit data (e.g., via a broadcast or a multi-cast) to receiving devices using an identical frequency channel. Each device in a SFN cluster transmit or receive data for a given frequency channel. The SFN cluster may include the neighboring base stations (e.g., the transmitters) and the client devices (e.g., the receivers) of one or more client service areas.

In one or more embodiments, the network attributes further specifies a grouping of client devices within a SFN cluster performed based on a channel quality index (CQI) of each client device. In one or more embodiments, a CQI is a value that indicates a channel quality provided to a client device by a neighboring base station. For example, in a long-term evolution (LTE) system, the CQIs may be indicated using integers between 1 and 15. Each client device may be associated with one of the fifteen CQIs based on, for example, a level of modulation performed during the transmission of data from the neighboring base station to the client device.

In one or more embodiments, the network attributes further specify a secondary grouping of the client devices using the CQIs to determine a bitrate of transmission based on the grouping of CQIs. For example, a first grouping may include CQIs of values between 1 and 10. The client devices in the first grouping may obtain the transmission at a first bitrate. A second grouping of CQIs may be for the values between 11 and 15. The client devices in the second grouping may obtain the transmission at the second bitrate. While embodiments disclosed herein discuss the grouping of CQIs as being assigned bitrates, other network attributes may be assigned to each grouping of CQIs. For example, a video format (e.g., 720p, 1080p, 4K, etc.) may be assigned to each CQIs.

In one or more embodiments disclosed herein, the modifications discussed throughout steps 202 and 204 include modifying the groupings of CQIs (e.g., how the CQIs are grouped), modifying an SFN layout (e.g., modifying which client service regions are associated with which SFN clusters), modifying the bitrate for each grouping of CQIs, and modifying the number of groupings of CQIs for a SFN clusters, the total number of SFN clusters. Other modifications may be performed without departing from this disclosure. In one or more embodiments, each multivariable chromosome obtained in the initial population is generated as a result of a modification of another multi-variable chromosome.

In step 204, a modification is performed to at least one of the multi-variable chromosomes in the current generation to obtain a new generation of multi-variable chromosomes. In one or more embodiments, step 204 may be performed following step 208 (e.g., after steps 204-206 have been performed at least once) or following step 204 (e.g., after the initial population is obtained). In such embodiments in which step 204 follows step 202, the modification includes generating additional multi-variable chromosomes based on the modifications discussed in step 202. The collective set of multi-variable chromosomes obtained in step 202 and 204 may be referred to as the current generation of multi-variable chromosomes.

In such embodiments in which the modification follows step 208, the modification includes determining a set of parent chromosomes of the current generation and obtaining the new current generation using the set of parent chromosomes. The set of parent chromosomes is determined by selecting a set of high valued multi-variable chromosomes. The set may be based on a predetermined number of multi-variable chromosomes expected to serve as parent chromosomes in each generation. The set of parent chromosomes may further be based on the confidence value (discussed in step 206) of the multi-variable chromosomes in the current generation. For example, the set of parent chromosomes may be selected as the multi-variable chromosomes that are part of the highest 25% of confidence values for the current generation.

The set of parent chromosomes may be modified as discussed throughout this disclosure (e.g., as discussed in step 202) to generate the new current generation. The set of parent chromosomes may be included in the new current generation. Conversely, any multi-variable chromosome in the previous generation that are not in the set of parent chromosomes are not included in the new current generation.

In step 206, a fitness function is performed on each of the current generation of multi-variable chromosomes to obtain a confidence value for each multi-variable chromosome. In one or more embodiments, the fitness function is a set of calculations, or other processes, applied to the network configuration attributes of each multi-variable chromosomes. The fitness function may be performed by calculating an expected latency for a network configuration and an expected network bandwidth, and calculating a confidence score based on the expected latency and the expected network bandwidth. The resulting confidence value may be a measurement of the confidence in the corresponding network configuration to properly execute the transmission of media in the client environment. The confidence value may be generated for each multi-variable chromosome, as each multi-variable chromosome is associated with a potential network configuration.

In step 208, a determination is made about whether a termination condition is met. In one or more embodiments, the termination condition is a condition that warrants terminating the iterations of new current generations. The termination condition may be based, for example, on a predetermined number of iterations (e.g., a number of times a new current generation is obtained and processed via the steps of 204 and 206). Once the predetermined number of iterations have been implemented, the termination condition is met. If the termination condition is met, the method proceeds to step 210; otherwise, the method proceeds to step 204.

In step 210, a highest scoring multi-variable chromosome is selected based on the confidence values of the current generation. In one or more embodiments, the highest scoring multi-variable chromosome refers to the multi-variable chromosome of the most current generation that is associated with the highest confidence value.

In step 212, a network configuration is initiated on the client environment based on the selected multi-variable chromosome. In one or more embodiments, the network configuration is initiated by generating a configuration file and sending the configuration file to the media providing service. Alternatively, the configuration file is sent to each neighboring base station by the network configuration manager. The configuration file may specify the network configuration of the selected multi-variable chromosome. In this manner, the media that is transmitted by the media providing service is transmitted in accordance with the network configuration (e.g., using the specified SFN layout, the grouping of CQIs in each SFN cluster, and the corresponding bitrates for each medium).

### Example

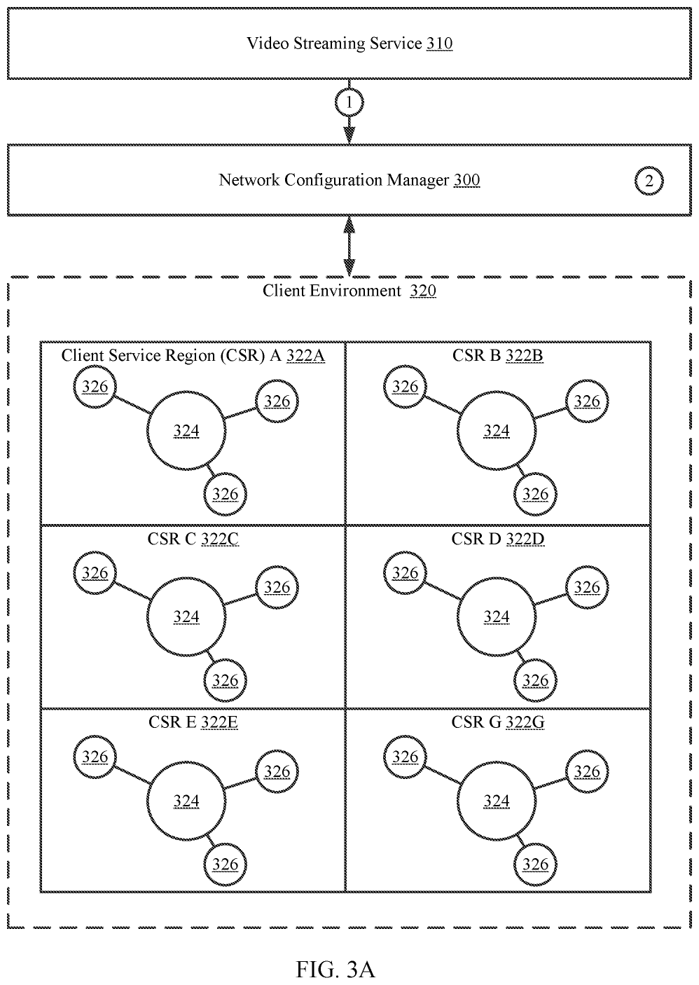

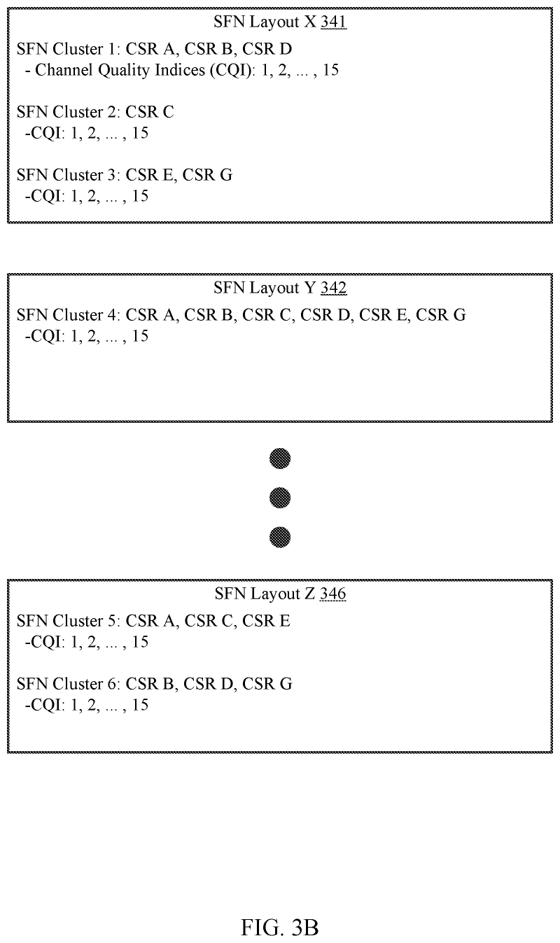

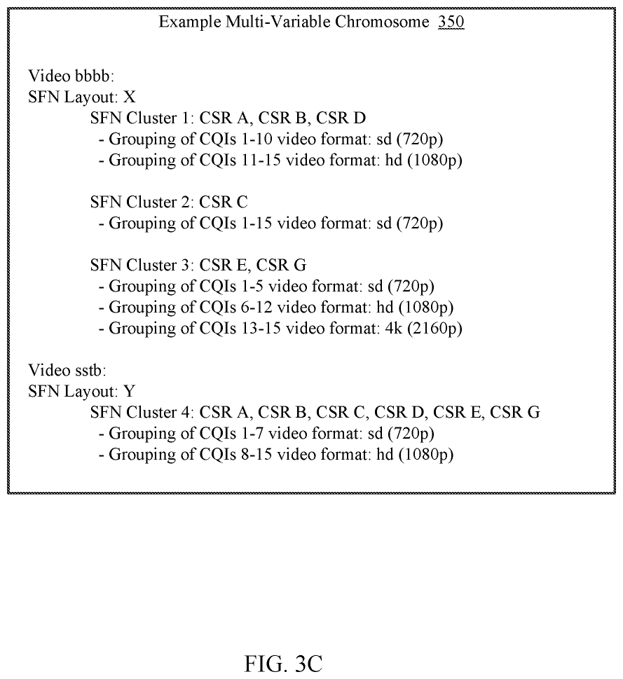

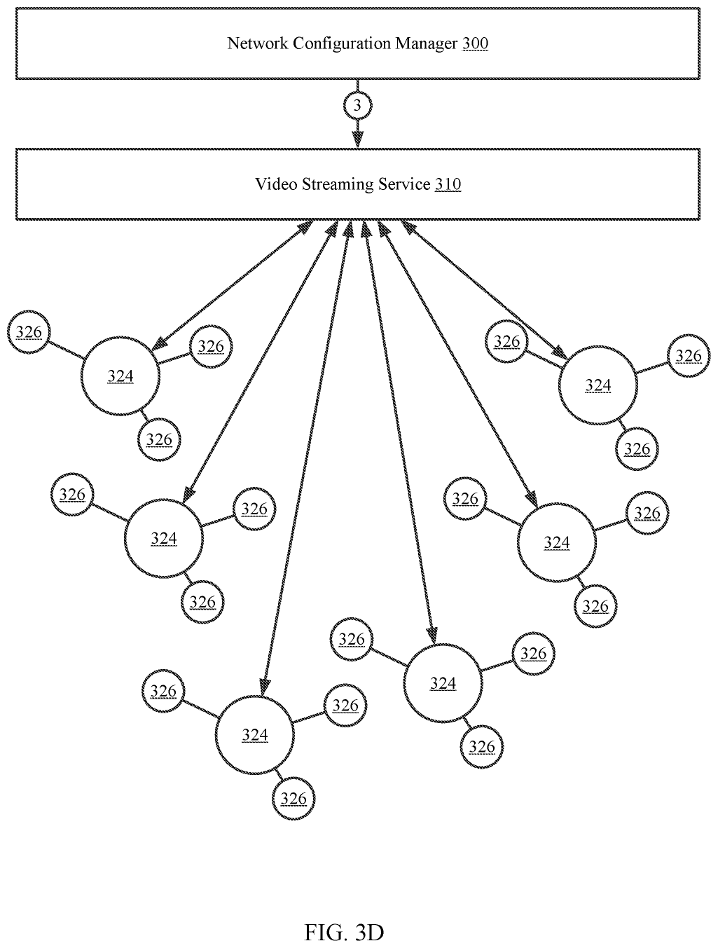

The following section describes an example. The example, illustrated in FIGS. 3A-3D, is not intended to limit embodiments of this disclosure and is independent from any other examples discussed in this disclosure. Any actions illustrated in FIGS. 3A-3D with circled numbers may be described below using brackets (e.g., “[1]”). Turning to the example, consider a scenario in which a video streaming service is streaming two videos to clients in a client environment.

FIG. 3A shows a diagram of an example system. For the sake of brevity, not all components of the example system are illustrated in FIG. 3A. The example system includes the video streaming service (310), a network configuration manager (300), and a client environment (320) that includes six client service regions (CSR A (322A), CSR B (322B), CSR C (322C), CSR D (322D), CSR E (322E), CSR G (322G). The client service regions (322A, 322B, 322C, 322D, 322E, 322G) may each include neighboring base stations (324) that provide broadcasts to client devices (326).

The video streaming service (310) sends a network configuration request to the network configuration manager (300) [1]. The network configuration request specifies configuring the distribution of the two videos to the client environment (320). Specifically, the network configuration specifies determining a single frequency network (SFN) layout of the client environment (320) and a video bitrate to be provided to each channel quality index (CQI) of each SFN cluster.

The network configuration manager (300), in response to the network configuration request, performs the method of FIG. 2 to determine a recommended network configuration for transmitting the two videos. In example embodiments, the network configuration can be an optimal configuration that includes an optimal combination of: a SFN layout per video, a grouping of CQIs per SFN cluster per SFN layout, and a video bitrate assigned to each grouping of CQIs. The method of FIG. 2 includes performing a genetic algorithm to a set of multi-variable chromosomes that each correspond to a network configuration.

To illustrate the potential network configurations that could be determined for the client environment (320), FIG. 3B shows a set of potential SFN layouts. Three example SFN layouts include SFN layout X (341), SFN layout Y (342), and SFN layout Z (346). While FIG. 3B only illustrates three potential SFN layouts, the network configuration manager (300) may consider many more SFN layouts.

Turning to FIG. 3B, SFN layout X (341) includes grouping the client service regions into SFN clusters 1, 2, and 3. SFN cluster 1 includes CSR A, CSR B, and CSR D. SFN cluster 2 includes CSR C, and SFN cluster 3 includes CSR E and CSR G. Each SFN cluster may include CQIs 1-15. In this example, CQI 1 relates to the group of client devices receiving the lowest level of modulation for transmitting data, and CQI 15 relates to the group of client devices receiving the highest level of modulation. SFN layout Y (342) includes grouping all client service regions (i.e., CSR A, CSR B, CSR C, CSR D, CSR E, CSR G into SFN cluster 4. SFN layout Z (346) includes grouping CSR A, CSR C, and CSR E into SFN cluster 5, and CSR B, CSR D, and CSR G into SFN cluster 6.

In this example, each video may be transmitted using one of the potential SFN layouts (e.g., SFN layout X (341), SFN layout Y (342), SFN layout Z (346), etc.).

To illustrate the potential network configurations that may be obtained, FIG. 3C shows an example multi-variable chromosome. The example multi-variable chromosome (350) is associated with a potential network configuration. The example multi-variable chromosome (350) includes network attributes that may be modified in copies of the multi-variable chromosomes to generate other multi-variable chromosomes (e.g., in accordance with FIG. 2).

The network attributes included in the example multi-variable chromosome (350) includes assigning SFN layout X (341) to video “bbbb” and assigning SFN layout Y (342) to video “sstb”. The network attributes further includes grouping the CQIs of each SFN cluster and assigning a video bitrate to each grouping. In the example multi-variable chromosome (350), SFN cluster 1 of SFN layout A has a first grouping of CQIs of 1-10 and a second grouping of CQIs 11-15. The first grouping is assigned a video format of 720p, and the second grouping is assigned a video format of 1080p.

Turning to the method of FIG. 2, the network configuration manager (300) generates a first iteration of a generation of multi-variable chromosomes. The first iteration (e.g., the initial population) includes performing modifications to copies of the example multi-variable chromosome (350). The modifications include modifying the groupings of CQIs for one of the SFN clusters, modifying the assigned SFN layout for one of the videos, and modifying the video formats for each grouping of CQIs for one of the SFN clusters. Each multi-variable chromosome in the initial population may be associated with one of the modifications of the example multi-variable chromosome.

The network configuration manager may continue the method of FIG. 2 and apply the fitness function to each of the multi-variable chromosomes in the initial population, generating a confidence value for each multi-variable chromosome, and determining a set of parent chromosomes based on the confidence values. The multi-variable chromosomes that are associated with the top 25% of confidence values are part of the first set of parent chromosomes. A second generation of multi-variable chromosomes is generated by applying one or more modifications to each of the set of parent chromosomes. The fitness function is applied to each of the second generation to generate the corresponding confidence values.

The process of determining a set of parent chromosomes, generating a new current generation using the set of parent chromosomes, and applying the fitness functions to each of the new current generations may be repeated until a termination condition is met. In this example, the termination condition specifies performing the process fifty times. Once the termination condition is met, the network configuration is determined by selecting the multi-variable chromosome, of the most recent generation, that is associated with the highest confidence value, and applying the network configuration of the selected multi-variable chromosome.

FIG. 3D shows a diagram of the example system at a later point in time. The network configuration manager (300) sends a configuration file to the video streaming service (310) that specifies the network configuration determined above [3]. The video streaming service (310) implementing the network configuration, transmits the two videos in accordance with the SFN layout to the neighboring base stations (324). The neighboring base stations (324) further implementing the network configuration, transmit the videos to the client devices (326) in accordance with the assigned video format for the corresponding SFN cluster and the assigned grouping of CQIs.

End of Example

As discussed above, embodiments disclosed herein may be implemented using computing devices. FIG. 4 shows a diagram of a computing device in accordance with one or more embodiments disclosed herein. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment disclosed herein, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment disclosed herein, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

One or more embodiments disclosed herein may be implemented using instructions executed by one or more processors of the computing device. Further, such instructions may correspond to computer readable instructions that are stored on one or more non-transitory computer readable mediums.

One or more embodiments disclosed herein may improve the operation of one or more computing devices. More specifically, embodiments disclosed herein provide a method for optimizing the network configuration used for the transmission of media. Embodiments disclosed herein provide a method for using confidence values to select, from a set of network configurations, a recommended network configuration. Further, embodiments disclosed herein provide a method for efficiently generating potential network configurations for the purpose of comparisons and analysis. The use of a genetic algorithm that performs iterations of multi-variable chromosomes, each associated with a potential network configuration, provides improved sets of network configurations, and optimizes the computing resources of the network configuration manager implementing the genetic algorithm to reduce the time taken to find the optimal network configuration.

While the disclosure has been described above with respect to a limited number of embodiments, those skilled in the art, having the benefit of this disclosure, will appreciate that other embodiments can be devised which do not depart from the scope disclosed herein as disclosed herein. Accordingly, the scope disclosed herein should be limited only by the attached claims.

What is claimed is:

1. A method for determining a network configuration, the method comprising:
obtaining, by a network configuration manager, a network configuration request for configuring client service regions,
wherein the network configuration specifies configuring the transmission of media from a media providing service to neighboring base stations of the client service regions;
in response to the obtaining:
obtaining a current generation of multi-variable chromosomes;
applying a fitness function on each of the current generation to obtain a set of confidence scores, wherein each of the set of confidence scores corresponds to one of the current generation of multi-variable chromosomes;
selecting, based on the set of confidence scores, a highest scored multivariable chromosome, wherein the highest scored multi-variable chromosome comprises a plurality of network attributes;
based on the selecting, determining the network configuration using the plurality of network attributes; and
initiating the network configuration on the neighboring base stations.

2. The method of claim 1, further comprising:
prior to obtaining the current generation:
obtaining a first multi-variable chromosome, wherein the first multi-variable chromosome comprises a second plurality of network configuration attributes;
applying a plurality of modifications to copies of the second plurality of network configuration attributes to obtain an initial population of multi-variable chromosomes;
applying the fitness function on each of the initial population to obtain a second set of confidence scores, wherein each of the second set of confidence scores corresponds to one of the initial population of multi-variable chromosomes;
making a determination that a termination threshold has not been reached; and
based on the determination, applying a second plurality of modifications to the initial population to obtain the current generation.

3. The method of claim 1, wherein the network configuration request is obtained from a media providing service.

4. The method of claim 3, wherein the media providing service distributes a video stream via the network configuration.

5. The method of claim 4, wherein the plurality of network configuration attributes comprises at least one of: a single frequency network (SFN) layout of the client service regions for the video stream, a set of SFN clusters based on the SFN layout, and a set of video bitrates of the video stream for each of the set of SFN clusters.

6. The method of claim 5, wherein the plurality of network configuration attributes further comprises at least one of: a second SFN layout of the client service regions for a second video stream, a second set of SFN clusters based on the second SFN layout, and a second set of video bitrates of the second video stream for each of the second set of SFN clusters.

7. The method of claim 1, wherein applying the fitness function comprises:
calculating an expected latency and an expected network bandwidth of each client service region using the plurality of network attributes; and
applying a second function to the expected network bandwidth and expected latency to obtain a confidence score of the highest scoring multi-variable chromosome.

8. The method of claim 1, wherein initiating the network configuration comprises sending a configuration file to each of the neighboring base stations, and wherein the configuration file comprises the plurality of network attributes.

9. A non-transitory computer readable medium comprising computer readable program code, which when executed by a computer processor enables the computer processor to perform a method for determining a network configuration, the method comprising:
obtaining, by a network configuration manager, a network configuration request for configuring client service regions,
wherein the network configuration specifies configuring the transmission of media from the media providing service to neighboring base stations of the client service regions;
in response to the obtaining:
obtaining a current generation of multi-variable chromosomes;
applying a fitness function on each of the current generation to obtain a set of confidence scores, wherein each of the set of confidence scores corresponds to one of the current generation of multi-variable chromosomes;
selecting, based on the set of confidence scores, a highest scored multivariable chromosome, wherein the highest scored multi-variable chromosome comprises a plurality of network attributes;
based on the selecting, determining the network configuration using the plurality of network attributes; and
initiating the network configuration on the neighboring base stations.

10. The non-transitory computer readable medium of claim 9, further comprising:
prior to obtaining the current generation:
obtaining a first multi-variable chromosome, wherein the first multi-variable chromosome comprises a second plurality of network configuration attributes;
applying a plurality of modifications to copies of the second plurality of network configuration attributes to obtain an initial population of multi-variable chromosomes;
applying the fitness function on each of the initial population to obtain a second set of confidence scores, wherein each of the second set of confidence scores corresponds to one of the initial population of multi-variable chromosomes;
making a determination that a termination threshold has not been reached; and
based on the determination, applying a second plurality of modifications to the initial population to obtain the current generation.

11. The non-transitory computer readable medium of claim 9, wherein the network configuration request is obtained from a media providing service.

12. The non-transitory computer readable medium of claim 11, wherein the media providing service distributes a video stream via the network configuration.

13. The non-transitory computer readable medium of claim 12, wherein the plurality of network configuration attributes comprises at least one of: a single frequency network (SFN) layout of the client service regions for the video stream, a set of SFN clusters based on the SFN layout, and a set of video bitrates of the video stream for each of the set of SFN clusters.

14. The non-transitory computer readable medium of claim 13, wherein the plurality of network configuration attributes further comprises at least one of: a second SFN layout of the client service regions for a second video stream, a second set of SFN clusters based on the second SFN layout, and a second set of video bitrates of the second video stream for each of the second set of SFN clusters.

15. The non-transitory computer readable medium of claim 9, wherein applying the fitness function comprises:
calculating an expected latency and an expected network bandwidth of each client service region using the plurality of network attributes; and
applying a second function to the expected network bandwidth and expected latency to obtain a confidence score of the highest scoring multi-variable chromosome.

16. A system comprising:
a media providing service;
a first client service region comprising a neighboring base station;
a processor; and
a network configuration manager executing on the processor and programmed to:
obtain a network configuration request, from the media providing service, for configuring client service regions,
wherein the network configuration specifies configuring the transmission of media from the media providing service to the neighboring base station;
in response to the obtaining:
obtain a current generation of multi-variable chromosomes;
apply a fitness function on each of the current generation to obtain a set of confidence scores, wherein each of the set of confidence scores corresponds to one of the current generation of multi-variable chromosomes;
select, based on the set of confidence scores, a highest scored multivariable chromosome, wherein the highest scored multi-variable chromosome comprises a plurality of network attributes;
based on the selecting, determine the network configuration using the plurality of network attributes; and
initiate the network configuration on the neighboring base station.

17. The system of claim 16, wherein the network configuration manager is further programmed to:
prior to obtaining the current generation:
obtain a first multi-variable chromosome, wherein the first multi-variable chromosome comprises a second plurality of network configuration attributes;
apply a plurality of modifications to copies of the second plurality of network configuration attributes to obtain an initial population of multi-variable chromosomes;
apply the fitness function on each of the initial population to obtain a second set of confidence scores, wherein each of the second set of confidence scores corresponds to one of the initial population of multi-variable chromosomes;
make a determination that a termination threshold has not been reached; and
based on the determination, apply a second plurality of modifications to the initial population to obtain the current generation.

18. The method of claim 1, wherein applying the fitness function comprises:
calculating an expected latency and an expected network bandwidth of the first client service region using the network attributes; and
applying a second function to the expected network bandwidth and expected latency to obtain a confidence score of the highest scoring multi-variable chromosome.

19. The method of claim 1, wherein initiating the network configuration comprises sending a configuration file to each of the neighboring base stations, and wherein the configuration file comprises the plurality of network attributes.

20. The system of claim 16, wherein the media providing service distributes a video stream via the network configuration.
